(19) United States
(12) Patent Application Publication
(10) Pub. No.: US 2020/0125533 A1
(43) Pub. Date: Apr. 23, 2020

(54) SYSTEM AND METHOD FOR LOCATING A FILE CREATED BY A PROCESS RUNNING IN A LINUX CONTAINER

(71) Applicant: Outcold Solutions LLC, Kirkland, WA (US)

(72) Inventor: Denis Gladkikh, Redmond, WA (US)

(21) Appl. No.: 16/373,189

(22) Filed: Apr. 2, 2019

Related U.S. Application Data
(60) Provisional application No. 62/766,500, filed on Oct. 22, 2018.

(51) Int. Cl. G06F 16/14; G06F 9/455

(52) U.S. Cl. CPC G06F 16/148; G06F 2009/45579; G06F 2009/45595; G06F 9/45558

(57) ABSTRACT

Systems and methods for locating a file created by a process running in a LINUX container and a corresponding LINUX system are provided, where the method can include: obtaining access to a top level of a host's filesystem having one or more mounted volumes therein; establishing a connection to a system for managing containers; obtaining, from the system for managing containers, a list of containers having the mounted volumes; and matching a file in the filesystem hierarchy to the container by using sources of the mounted volumes. A system for carrying out these methods can be arranged on the host and the system for managing containers can be either on or off-host. These systems and methods allow a less complex and costly means to locate files on mounted volumes of containers without recourse to a logging library (e.g., sidecar) or log forwarder.

### CLAIM OF PRIORITY UNDER 35 U.S.C. § 119

The present application for patent claims priority to Provisional Application No. 62/766,500 entitled “System and Method for Locating a File Created by Process Running in a Linux Container” filed Oct. 22, 2018, and assigned to the assignee hereof and hereby expressly incorporated by reference herein.

### FIELD OF THE DISCLOSURE

The present disclosure relates generally to virtualization in computing. In particular, but not by way of limitation, the present disclosure relates to systems, methods and apparatuses for operating-system-level virtualization.

### BACKGROUND

Virtual machines (VM) are often used in computing to emulate and provide the functionality of a physical computer. As a result, multiple full virtualization VM instances can be used on a single physical computer to run multiple operating systems where each full virtualization VM instance executes its own operating system. This use of multiple full virtualization VM instances on the same computer can provide some advantageous security and resource management benefits; however, each full virtualization VM instance is slow to start and stop with it having to boot its own operating system each time.

One solution to cumbersome booting problems is to instead use operating-system-level-virtualization instances, or containers. These containers are isolated instances that can run simultaneously on a single operating system, allowing them to start and stop much faster and save on overall resource usage. Containers also maintain some of the key benefits of VM functionality, such as security and resource management. For example, in a server with eight CPUs, a container may be configured to use only two of the CPUs, limiting the resources available to the one or more processes within the container.

The isolation of each container can, however, significantly limit the ability of the one or more processes to output data, such as logs, from the container. Even where one process is present in a container, the single process can forward to the stdout and stderr data streams one type of log (e.g., information about the process itself such as that it started, completed, had an error, or the initialization configuration), but write to the file system a different type of log (e.g., information about the processed data). In particular, only the main process within the container can output data to the exterior execution environment via its standard out (stdout) and standard error (stderr) output streams. Getting data from the stdout and stderr output streams of any subprocesses, or logs written to the files inside of the container by the modules of the main process or its subprocesses, within the container can be problematic, especially given that the data within the container does not persist after the container stops.

One approach currently used, as shown in FIG. 1, is to configure the subprocesses (or submodules of a primary process, where the submodules can run in the primary process, but produce different types of logs) to send their data output to the main process within the container. The main process is then configured to output the data output from the subprocesses through its stdout and stderr output streams along with its own data output. If the processes are outputting logging data, the main process stdout and stderr output streams of each container can then be sent to a logging aggregation system via an on-server process for managing containers, such as a container runtime with a logging driver. However, no indication is provided by default to associate a specific subprocess or module of the primary process with its data output (i.e., it can be difficult to later track the source of a data output). The subprocesses or modules of the primary process can be customized to provide this indication in their data outputs, but customization may not be feasible if the subprocess is not owned, overly complex, or an old, legacy process that is being ported.

Another approach currently used, as shown in FIG. 2, is to create and associate a logging library if the processes are outputting logging data, with each existing sub-process. Each logging library has access to the subprocess data outputs within its associated container and is configured to modify the subprocess data outputs to indicate which subprocess generated the data output. Each logging library then outputs the modified subprocess data outputs to a log aggregation system. As in the previously mentioned approach, the main process stdout and stderr output streams of each container are sent to a logging aggregation system via an on-server process for managing containers with a logging driver. Unfortunately, it is time intensive and sometimes difficult to set up logging libraries for each existing container. Logging libraries may not always be available for a given programming language, or a given application running in a user's container. As such, configuration of the logging libraries can add an additional level of operation complexity. Moreover, the logging libraries increase the overall resource usage of this approach.

Another approach, as shown in FIG. 3, is to create and associate a dedicated logging container, called a “sidecar,” with every container. Subprocesses in a container can be forced to write to a volume that is shared with the associated “sidecar” logging container. The user can configure a “sidecar” logging container to forward to a log aggregation system. Unfortunately, that adds additional operational complexity, so a user often needs to configure a sidecar for every container that has a problem forwarding logs produced from subprocesses or modules of the primary process. The user may also need to monitor every “sidecar” container to make sure that it operates appropriately. As seen, the sidecar approach increases overall resource usage.

Another approach currently used, as shown in FIG. 4, is to allow the containers to store subprocess output data in data files on a file system of the server hosting the containers. The container runtime, which is an operating-system-level virtualization that manages containers on a single server, is allowed to create volumes in a directory of the server file system. The container runtime can then, when needed, create and assign (or mount) these volumes to ones of the containers on the server, and the containers can then use the volumes to store subprocess output data in data files. In the FIG. 4 example of this “volume mount” approach, the stored subprocess output data files contain logging data that can be accessed by a log forwarder that finds (e.g., searches for “.log” but not “.dat” files) the stored logging data files in the mounted volumes on server file system directory and sends them to a log aggregation system. As in the previously mentioned approaches, the main process stdout and stderr output streams of each container are sent to a logging aggregation system an on-server process for managing containers with a logging driver. However, the source (e.g., a specific container) of this data may not be known unless a user of the containers specifies names for each mounted volume that corresponds to and indicates the source container. For instance, the user can instruct the container runtime or orchestration framework to name a mounted volume with “{{.Task.Name}},” where the “.Task.Name” is a placeholder, which will generate a container name like “prod-tomcat.2.ez0jpuqe2mk16ppqnuffxqagl”. However, if the user mistypes the volume placeholder or forgets to include this placeholder, then the logging framework will no longer be able to match files to corresponding volumes. This need to customize the names of each mounted volume adds complexity to the process of using containers, increases the chances of a naming mistake by the user, and inhibits scaling of this approach.

### SUMMARY OF THE DISCLOSURE

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

Some embodiments of the disclosure may be characterized as a system for decreasing processor and memory resources used to locate one or more files in mounted volumes created by processes running in one or more operating system (e.g., LINUX) containers. The system can include a processing portion with one or more processing components therein. The system can also include a memory coupled to the processing portion and a process for managing containers. The server can be stored on the memory and can be executable on the processing portion. The server can include one or more containers, a file system having mounted volumes, and a data file locator and processing module. The one or more containers can have at least one process. At least one of the one or more containers can have one of the mounted volumes on the file system, and the one of the mounted volumes has an arbitrary file name unassociated with its one of the one or more containers. The data file locator and processing module can be stored on the memory and can be executable on the processing portion to form a communication connection with the process for managing containers. The data file locator and processing module can further be executable to request and receive a list of containers on the server having mounted volumes on the file system, along with a path to each of these mounted volumes. The data file locator and processing module can also be executable to obtain access to the file system. Given the communication connection and the list of containers, the data file locator and processing module can be executable to map files within each of the mounted volumes to corresponding containers via the path for each of the mounted volumes without analyzing all containers on the server.

Other embodiments of the disclosure may also be characterized as a method for decreasing processor and memory resources used to locate one or more files in mounted volumes created by processes running in one or more operating system (e.g., LINUX) containers. The method can include forming a communication connection with a process for managing containers. The method can also include requesting and receiving a list of containers on a server, at least one of the containers having a mounted volume on the file system, and further receiving a path to each of the mounted volumes. The method can further include obtaining access to a file system of the server. The method can yet further include mapping files within each of the mounted volumes to corresponding containers via the path for each of the mounted volumes.

Other embodiments of the disclosure can be characterized as a data file locator and processing module configured for storage on a memory of a server and configured to execute on a processing portion of the server. The server can have one or more containers and at least one of the one or more containers can have a mounted volume on the server's file system. The server can further have a process for managing containers internal to the server and can interact with a system for complex management of containers external to the server. The data file locator and processing module can include a communication connection sub module, a path locator sub module, an access sub module, and a mapper sub module. The communication connection sub module can be configured to form a communication connection with the process for managing containers. The path locator sub module can be configured to, via the communication connection, request and receive a list of all containers on the server having mounted volumes on the file system, along with a path to each of these mounted volumes. The access sub module can be configured to obtain access to the file system. The mapper sub module can be configured to map files within each of the mounted volumes to corresponding containers via the path for each of the mounted volumes, rather than utilizing a file name of the mounted volumes.

### BRIEF DESCRIPTION OF THE DRAWINGS

Various objects and advantages and a more complete understanding of the present disclosure are apparent and more readily appreciated by referring to the following detailed description and to the appended claims when taken in conjunction with the accompanying drawings:

FIG. 1 illustrates a prior art system for logging data generated by containers;

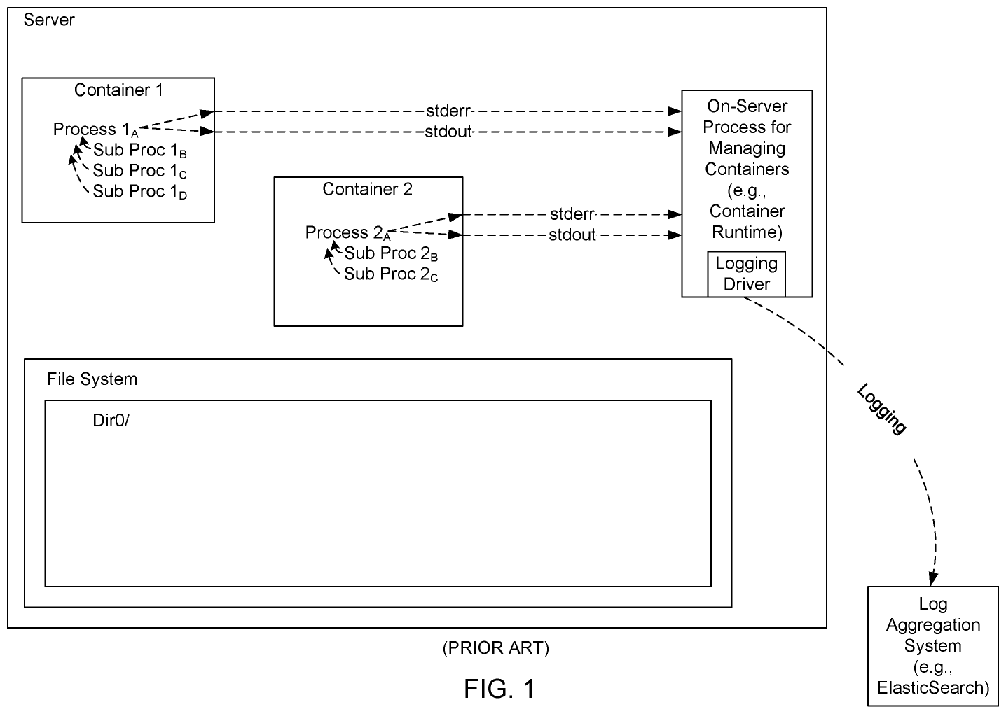

FIG. 2 illustrates another prior art system for logging data generated by containers;

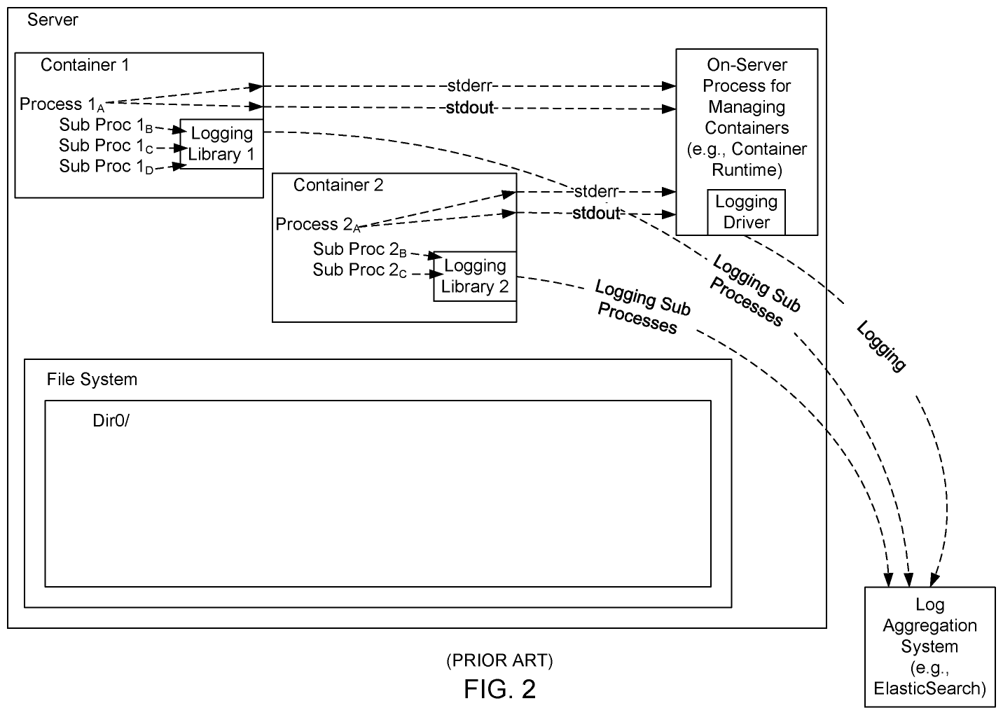

FIG. 3 illustrates another prior art system for logging data generated by containers;

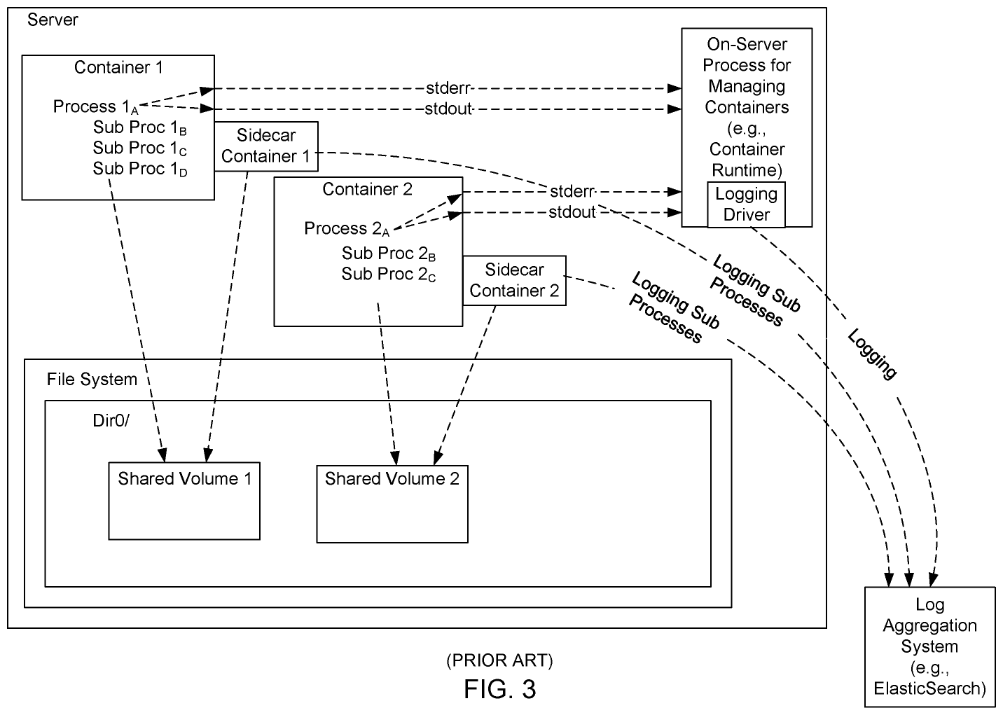

FIG. 4 illustrates another prior art system for logging data generated by containers;

FIG. 5 illustrates a first embodiment of a data file locator and processing module for locating a file in a mounted volume created by a process running in a LINUX container, where a process for managing containers is deployed on the same server as the data file locator and processing module;

FIG. 6 illustrates a second embodiment of a data file locator and processing module for locating a file in a mounted volume created by a process running in a LINUX container, where a system for managing containers is deployed outside the server hosting the data file locator and processing module;

FIG. 7 illustrates a first embodiment of a method for locating a file created by a process running in a LINUX container;

FIG. 8 illustrates a second embodiment of a method for locating a file created by a process running in a LINUX container;

FIG. 9 illustrates a third embodiment of a method for locating a file created by a process running in a LINUX container;

FIG. 10 illustrates an embodiment of details of a data file locator and processing module; and

FIG. 11 illustrates block diagram depicting physical components that may be utilized to realize the data file locator and processing module according to an exemplary embodiment.

### DETAILED DESCRIPTION

The word “exemplary” is used herein to mean “serving as an example, instance, or illustration.” Any embodiment described herein as “exemplary” is not necessarily to be construed as preferred or advantageous over other embodiments.

Preliminary note: the flowcharts and block diagrams in the following Figures illustrate the architecture, functionality, and operation of possible implementations of systems, methods and computer program products according to various embodiments of the present invention. In this regard, some blocks in these flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, can be implemented by special purpose hardware-based systems that perform the specified functions or acts, or combinations of special purpose hardware and computer instructions.

### Definitions

For the purposes of this disclosure, a “server” is a computer server or a virtual server, and in either case the server can share hardware resources with other virtual servers.

For the purposes of this disclosure, “standout error” (stderr) and “standard output” (stdout) are standard output streams created by the operating system between a main process running in a container and the main processes' execution environment (e.g., a container runtime). The system or user that creates a process can instruct that these streams be piped to other processes, which can then forward this data to a terminal or other user interface. They can also be piped to the file system for storage.

For the purposes of this disclosure, a “container runtime” is an operating-system level virtualization that manages containers on a single server or a virtual server. Some common, but non-limiting container runtimes are DOCKER, CRI-O, and CONTAINERD. These container runtimes can either be self-managed or managed by an orchestration framework, such as KUBERNETES, OPENSHIFT, AWS Elastic Container Server (ECS). Every server or virtual server hosting containers will have a container runtime.

For the purposes of this disclosure, an “orchestration framework,” or “orchestration software,” is a system that can manage containers on a single server, multiple servers, or one or more virtual servers, via the container runtime on each server or virtual server. The orchestration framework can be installed on the same or a separate server from the one running the container runtime that the orchestration framework is controlling.

The DOCKER Engine is one example of an orchestration framework. Here, the DOCKER Engine runs orchestration software on the same server where the container runtime is running. The container runtime can be implemented by the DOCKER Engine itself. Another example is DOCKER SWARM. SWARM runs orchestration software on a cluster with multiple servers working as one distributed cluster and using DOCKER Engine as the container runtime. Yet another example is KUBERNETES, which runs orchestration software on a cluster with multiple servers working as one cluster of servers. It uses container runtimes installed on these servers in the cluster. The container runtimes can be DOCKER Engine, CRI-O, or CONTAINERD.

For the purposes of this disclosure, a “data file” is a computer file stored on the file system of a server. The data file can be created by a process running inside of a container on the server. Data files can be text or binary files and some examples include, but are not limited to, machine-generated log files (text) and database data files (binary).

### Details of the Disclosure

One major drawback of the volume mount approach previously described is that each volume must be named to indicate which container is attached to it. The naming process is labor-intensive and naming mistakes can easily be made, causing uncertainty in which volume is attached to which container. Thus, a need has long existed for mapping data in mounted volumes to corresponding containers that does not involve complicated and non-scalable sidecar logging modules or mistake-prone processes that require mapping built into mounted volume naming.

The present disclosure solves the above-mentioned naming problem by introducing a data file locator and processing module that is configured to map files within each of the mounted volumes to corresponding containers using a list of containers on the server having mounted volumes and the path to these mounted volumes. One advantage of this path-based approach is that volume names can be chosen arbitrarily, either manually or automatically, for the mounted volumes while maintaining the ability to map the files in the mounted volumes to their corresponding containers, thus, reducing operability complexity and the risk of erroneous volume names.

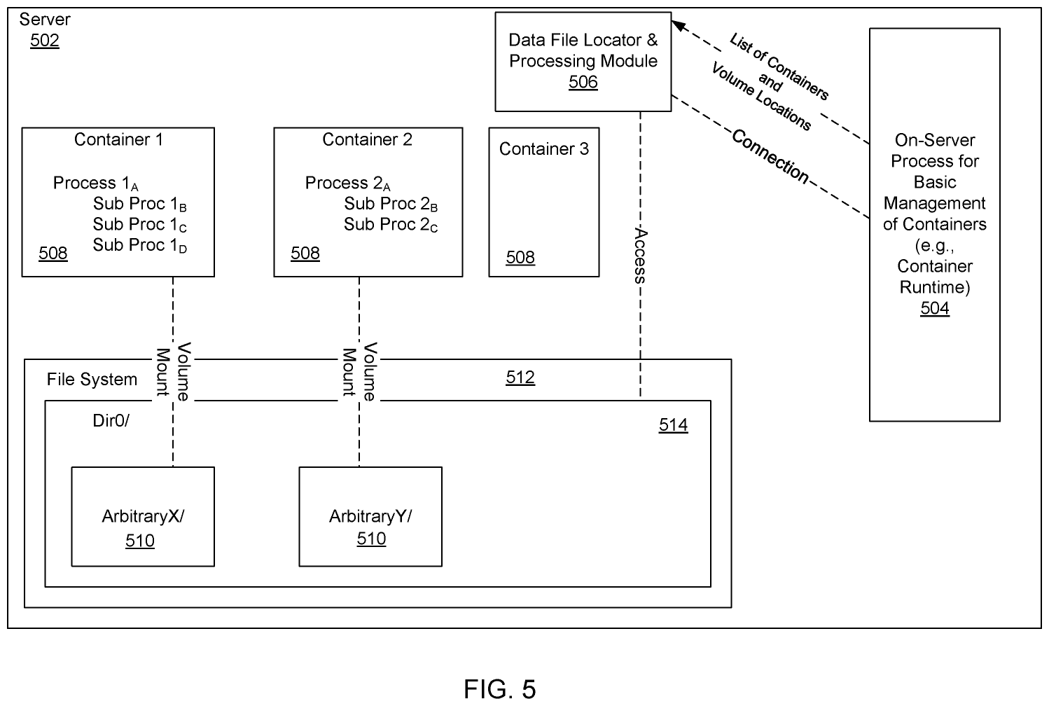

FIG. 5 illustrates an embodiment of the present disclosure that functions when no system for complex management of containers, such as an orchestration framework or orchestration software, is available. A system is shown having a processing portion with one or more processing components therein (not shown), a memory coupled to the processing portion (not shown), a process for managing containers 504, and a server 502 stored on the memory and executable on the processing portion. A data file locator and processing module 506, is stored on the memory of the server 502 and executed on the processing portion of the server 502, the server 502 having one or more containers 508 and at least one of the one or more containers having a mounted volume 510 on the server's file system 512, where the server 502 can be at least one of a computing device or a virtual machine. The server 502 shown has three containers 508 that are managed by a process for managing containers 504, which in this instance, is a process for basic management of containers 504, such as a container runtime. Container 1 and container 2 508 both contain a main process as well as multiple subprocesses and have mounted volumes 510 on the file system 512 of the server 502 with arbitrary file names unassociated with their corresponding containers 508. Specifically, container 1 508 has a mounted volume 510 with an arbitrary name “ArbitraryX” and container 2 508 has a mounted volume 510 with an arbitrary name “ArbitraryY” where both ArbitraryX and ArbitraryY are stored in the directory (e.g., Dir0 514) of the file system 512. In this embodiment container 1 and container 2 508 each have a single mounted volume 510, while container 3 508 does not have a mounted volume 510; however, in other embodiments a container 508 may have multiple mounted volumes 510, or multiple containers 508 may share a single mounted volume 510. It should be noted that while arbitrary naming of mounted volumes 510 is possible, a user may choose to select a specific mounted volume 510 name—though this is not required.

The data file locator and processing module 506 of FIG. 5 can form a communication connection with the process for basic management of containers 504. This communication connection allows the data file locator and processing module 506 to request and receive a list of containers 508 on the server 502 having mounted volumes 510 on the file system 512, along with a path to each of these mounted volumes 510, from the process for basic management of containers 504. In some embodiments, the list of containers 508 provided by the process for basic management of containers 504 may include containers 508 without mounted volumes 510 on the file system 512, which are then filtered out to obtain a list of containers 508 on the server 502 having mounted volumes 510 on the file system 512. The data file locator and processing module 506 additionally can obtain access to the file system 512 where mounted volumes 510 of the containers 508 are stored. Using the list of containers 508 having mounted volumes 510 and the path to each of the mounted volumes 510, the data file locator and processing module 506 can then locate and access files within each of the mounted volumes 510 and map those files to corresponding containers 508 via the path for each of the mounted volumes 510. This path-based mapping of files to containers 508 allows the files within the mounted volumes 510 to be processed while knowing their corresponding container 508 without some of the potential drawbacks of the naming, logging library, sidecar, or piggyback approaches described above. In some embodiments, the files within the mounted volumes 510 of the containers 508 can contain logging data from the processes and subprocesses of the containers 508. Additionally, in some embodiments, the data file locator and processing module 506 may be run in its own container 508 on the server 502, as a process on the server 502, or outside of the server 502. “Access” can include the ability to read data from memory or storage, and a configuration file executed by the user can give the system permission to access the file system.

Processing of files can include, but is not limited to, log forwarding, log transformation and forwarding (e.g., forwarding only select ones of all logs), hide sensitive information from the logs, transforming logs into structured events (e.g., extracting fields from the raw log messages), alerting based on raw logs (e.g., sending an alert when the log file contains an error or warning, or greater than 5 errors in a second), back up data in the mounted volumes (e.g., taking a ‘snapshot’ of data files in a mounted volume and forwarding them to a backup storage).

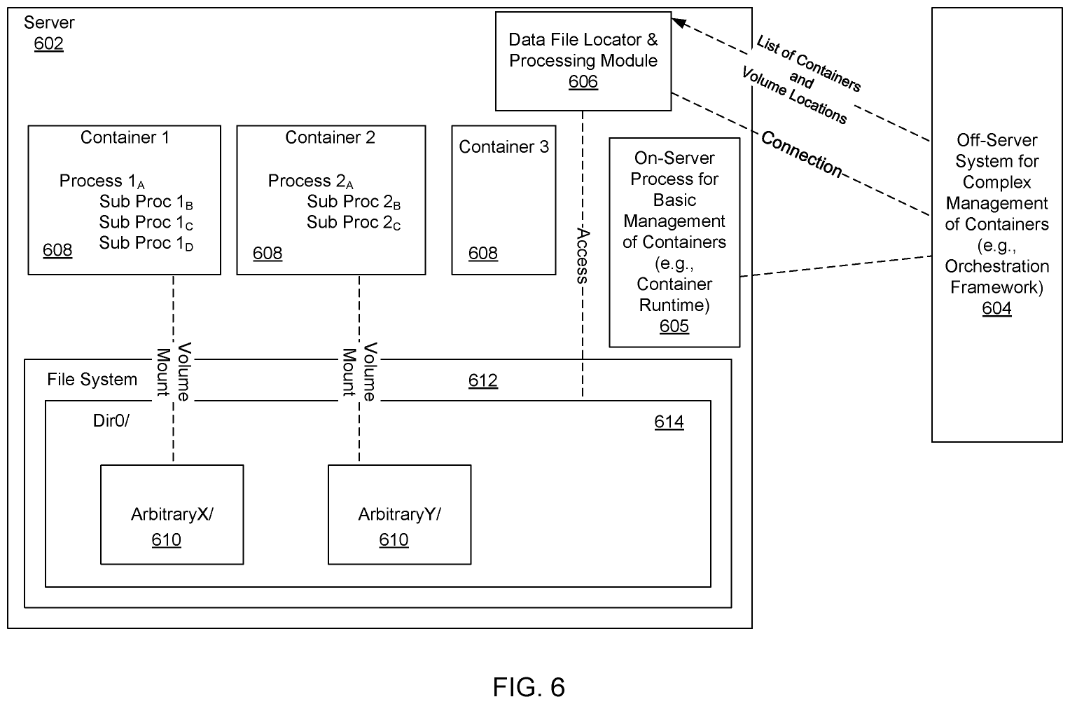

FIG. 6 illustrates an embodiment of the present disclosure where a process for complex management of containers, such as an orchestration framework or orchestration software, is available. A system is shown having a processing portion (not shown) with one or more processing components (not shown) therein, a memory (not shown) coupled to the processing portion, a process for managing containers 605, and a server 602 stored on the memory and executable on the processing portion. A data file locator and processing module 606, is stored on the memory of the server 602 and executed on the processing portion of the server 602, the server 602 having one or more containers 608 and at least one of the one or more containers 608 having a mounted volume 610 on the server's file system 612, where the server 602 can be at least one of a computing device or a virtual machine. The server 602 shown has three containers 608 that are managed by the on-server process for managing containers 605, which is a process for basic management of containers, such as a container runtime. An off-server system for complex management of containers 604, such as an orchestration framework, interacts with the on-server process for basic management of containers 605 in order to assist in the management of the containers 608 on the server 602. The off-server system for complex management of containers 604 can include databases, API servers, and various systems, to name a few non-limiting examples. The off-server system for complex management of containers 604 may provide additional functionality in container management, including, but not limited to, creating a set of one or more containers, rescheduling failed containers, linking containers, load balancing over container sets, and other container management automations. In some embodiments, the off-server system for complex management of containers 604 can be at least one of on-server (not shown) or integrated with the process for basic management of containers 605 (not shown). Container 1 and container 2 608 both contain a main process as well as multiple subprocesses and have mounted volumes 610 on the file system 612 of the server 602 with arbitrary file names that can be unassociated with their corresponding containers 608. Specifically, container 1 608 has a mounted volume 610 with an arbitrary name “ArbitraryX” and container 2 608 has a mounted volume 610 with an arbitrary name “ArbitraryY” where both ArbitraryX and ArbitraryY are stored in the directory (e.g., Dir0 614) of the filesystem 612. In this embodiment container 1 608 and container 2 608 each have a single mounted volume 610, while container 3 608 does not have a mounted volume 610; however, in other embodiments a container 608 may have multiple mounted volumes 610, or multiple containers 608 may share a single mounted volume 610.

The data file locator and processing module 606 of FIG. 6 can form a communication connection with the process for complex management of containers. This communication connection allows the data file locator and processing module 606 to request and receive a list of containers 608 on the server 602 having mounted volumes 610 on the file system 612, along with a path to each of these mounted volumes 610, from the off-server system for complex management of containers 604. The off-server system for complex management of containers 604 may also provide additional information related to the containers 608, such as user-attached labels, project names, or other metadata. In some embodiments, the list of containers 608 provided by the off-server system for complex management of containers 604 may include containers 608 without mounted volumes 610 on the file system 612, which are then filtered out to obtain a list of containers 608 on the server 602 having mounted volumes 610 on the file system 612. The data file locator and processing module 506 can additionally obtain access to the file system 512 where mounted volumes of the containers 608 are stored. Using the list of containers 608 having mounted volumes 610 and the path to each of the mounted volumes 610, the data file locator and processing module 606 can then locate and access files within each of the mounted volumes 610 and map those files to corresponding containers 608 via the path for each of the mounted volumes 610. This path-based mapping of files to containers 608 allows the files within the mounted volumes 610 to be processed while knowing their corresponding container 608 without some of the potential drawbacks of the naming, logging library, sidecar, or piggyback approaches described above. In some embodiments, the files within the mounted volumes 610 of the containers 608 can contain logging data from the processes and subprocesses of the containers 608. Additionally, in some embodiments, the data file locator and processing module 606 may be run in its own container 608 on the server 602, as a process on the server 602, or outside of the server 602.

In some embodiments, the same data file locator and processing module 506, 606 can be used regardless as to whether the user has scheduled containers using the basic 504 or complex 604 process/system and regardless as to whether that process/system is on server 504 or off-server 604. The user can indicate to the data file locator and processing module 506, 606 which process/system 504, 604 is being used, and the data file locator and processing module 506, 606 will then make a connection with the appropriate process 504 or system 604. It is also possible that the list of containers can be obtained from either the basic process 504 or the complex system 604, and in such cases the user can instruct the data file locator and processing module 506, 606 to use a preferred process/system 504, 604. Utilizing the complex system 604 can provide the same information as calling on the basic process 504, as well as additional metadata associated with the containers that may be useful for the user (e.g., user-defined labels, projects).

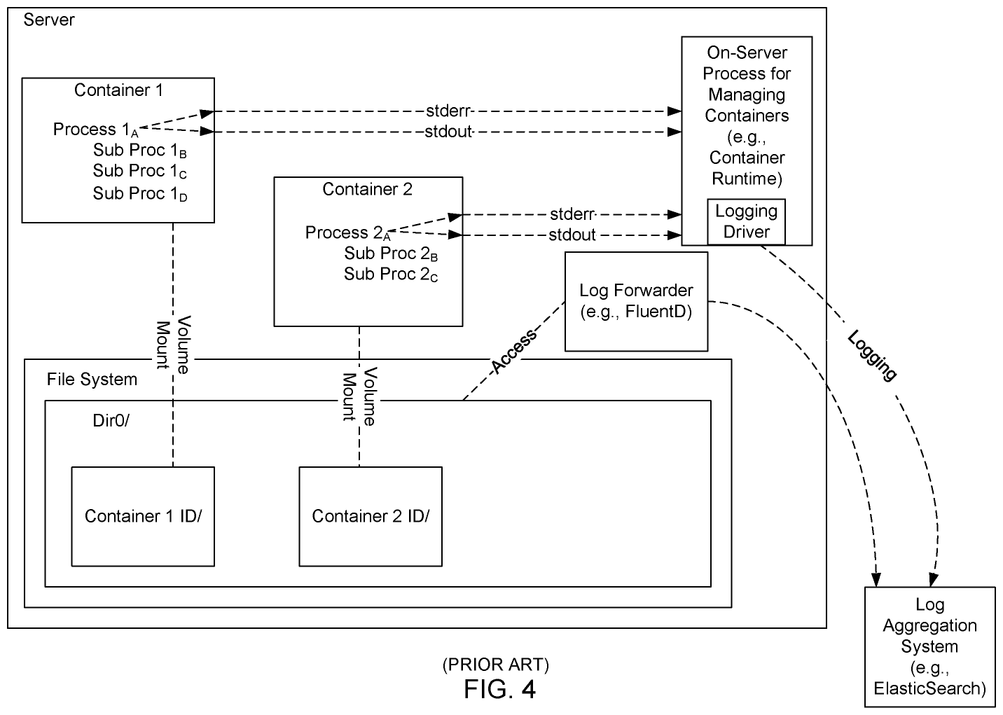

One advantage of the herein disclosed systems, methods, and apparatus is the ability to analyze less than all containers and/or mounted volumes in order to map files in the file system to corresponding containers. This ability reduces system resource usage and enhances the speed of the computer's operation. Fewer I/O operations may occur, which results in lower CPU and memory load. For instance, a server may include 100 containers, 50 of them having mounted volumes. Twenty five of these fifty may have logs with file names *.log. The typical approach, as seen in FIG. 4, looks for all files in the file system having *.log. Thus, a log forwarder looks under 50 volumes searching for files with names that satisfy the pattern “*.log”. In the case of FIGS. 5 and 6, the data file locator and processing module can use annotations to allow a user to tell the data file locator and processing module in which volumes the data file locator and processing module should look for desired files. For instance, the user can specify 25 of the volumes in which the data file locator and processing module should look for desired files, and as a result FIGS. 5 and 6 show systems where the data file locator and processing module would only need to look in the named 25 volumes rather than the 50 that the prior art would analyze. Annotations can also be used to allow the user to tell the data file locator and processing module to apply a transformation to the logs before forwarding them, including hiding sensitive information and applying sampling (e.g., only forward 20% of the logs).

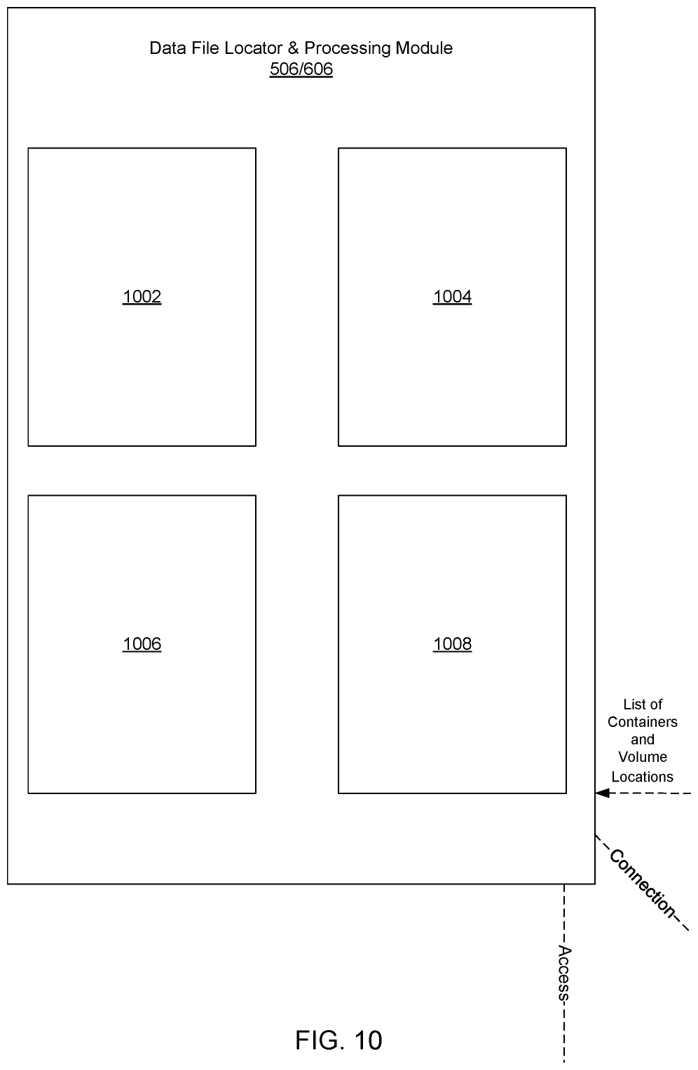

FIG. 10 illustrates one embodiment of details of a data file locator and processing module such as 506 or 606. The data file locator and processing module 506/606 is comprised of a communication connection sub module 1002 configured to form a communication connection with the process for managing containers (not shown in FIG. 10), a path locator sub module 1004 configured to request and receive a list of all containers on the server having mounted volumes on the file system, along with a path to each of these mounted volumes, an access sub module 1006 configured to obtain access to the file system, and a mapper sub module 1008 configured to map files within each of the mounted volumes to corresponding containers via the path for each of the mounted volumes, rather than utilizing a file name of the mounted volumes (recall FIG. 4).

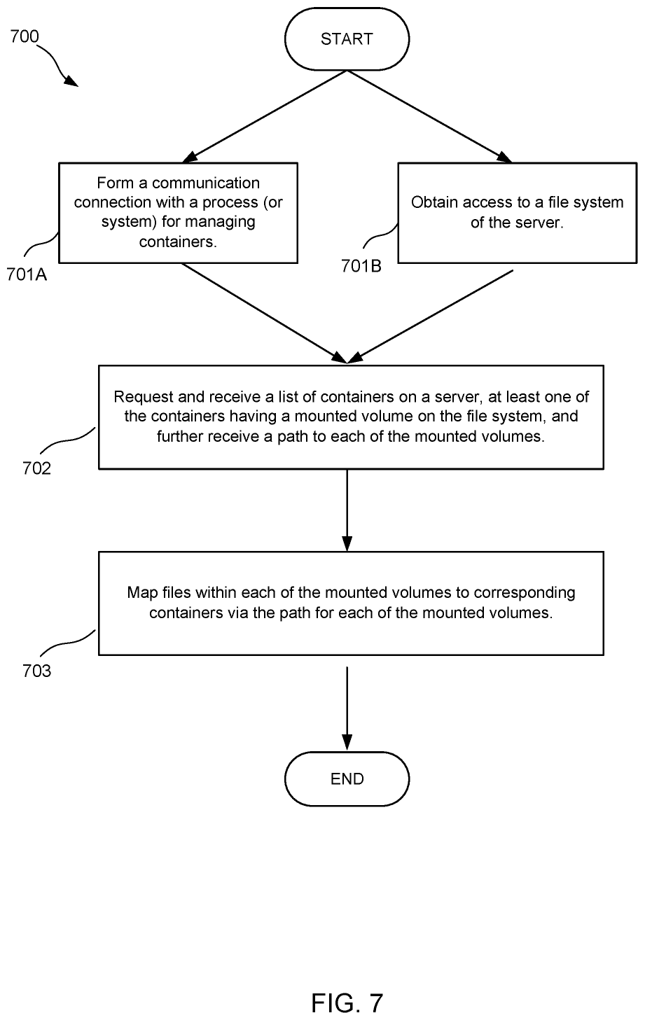

FIG. 7 illustrates a flowchart of one embodiment of a method for operating a data file locator and processing module (such as those shown in FIGS. 5 and 6). The data file locator and processing module may be arranged on a server hosting the data file locator and processing module, running in its own container or as a process on the server. A server can be at least one of a computing device or a virtual machine. In other embodiments, the data file locator and processing module may be arranged outside of the server. The data file locator and processing module may first obtain access to a file system of a server, on which mounted volumes of containers are stored (Block 701B), and can form a communication connection with a process for managing containers or an off-server system for complex management of containers (e.g., an orchestration framework or orchestration software as seen in, for instance, FIG. 6) (Block 701A). A process for managing containers may be located on-server while a system for managing containers may be located off-server. Blocks 701A and 701B may occur in any order, so long as they are both completed before Block 702. The data file locator and processing module can then request and receive a list of containers on the server, at least one of the containers having a mounted volume on the file system, and further receive a path to each of the mounted volumes (Block 702). Finally, the data file locator and processor module maps files within each of the mounted volumes to corresponding containers via the path for each of the mounted volumes (Block 703) and specific data can be processed. This path-based mapping of files to containers allows the files within the mounted volumes to be processed while knowing their corresponding container without some of the potential drawbacks of the naming, logging library, sidecar, or piggyback approaches described above. In some embodiments, the files within the mounted volumes of the containers can contain logging data from the processes and subprocesses of the containers. This also reduces memory and processor usage since less than all mounted volumes are processed as is required in the art.

In some embodiments, the list of containers provided in Block 702 may include containers without mounted volumes on the file system (e.g., all containers on the file system), which are then filtered out to obtain a list of containers on the server having mounted volumes on the file system. Alternatively, the provided list may only include those containers having mounted volumes on the file system.

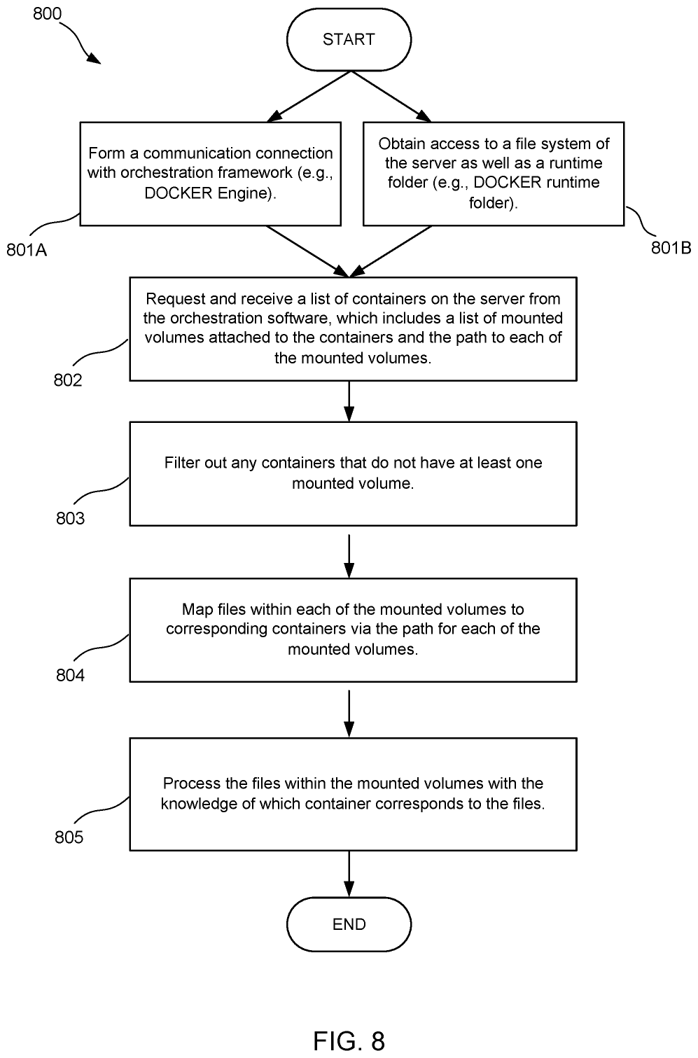

FIG. 8 illustrates a flowchart of an embodiment of a method for operating a data file locator and processing module (such as those shown in FIGS. 5 and 6) where the process for managing containers is an on-server process for complex management of containers (e.g., realized by the DOCKER Engine). The data file locator and processing module may be arranged on a server hosting the data file locator and processing module, running in its own container or as a process on the server. A server can be at least one of a computing device or a virtual machine. In other embodiments, the data file locator and processing module may be arranged outside of the server. The data file locator and processing module may first obtain access to a file system of a server, on which mounted volumes of containers are stored (Block 801B), as well as a runtime folder (e.g., DOCKER runtime folder) typically with the path “/var/lib/docker),” and can form a communication connection with an orchestration framework (e.g., the DOCKER Engine orchestration software) (Block 801A). Blocks 801A and 801B may occur in any order, so long as they are both completed before Block 802. The data file locator and processing module can then request and receive a list of containers on the server from the orchestration framework, which includes a list of mounted volumes attached to the containers and the path to each of the mounted volumes (Block 802). For example, the orchestration framework may provide a path to a mounted volume with the format “/var/lib/docker/volumes/name_of_the_volume/” where name_of_the_volume is the volume's name. The data file locator and processing module can then filter out any containers in the list of containers that do not have at least one mounted volume (Block 803). Using the filtered list of containers, the data file locator and processor module can then map files within each of the mounted volumes to corresponding containers via the path for each of the mounted volumes (Block 804). Finally, the data file locator and processing module can process the files within the mounted volumes with the knowledge of which container corresponds to the files (Block 805) without some of the potential drawbacks of the naming, logging library, sidecar, or piggyback approaches described above. In some embodiments, the files within the mounted volumes of the containers can contain logging data from the processes and subprocesses of the containers. With the knowledge of which container corresponds to specific files, memory and processor usage can be reduced by processing only a subset of all the mounted volumes or a subset of files within the mounted volumes, rather than processing all mounted volumes as required in the art.

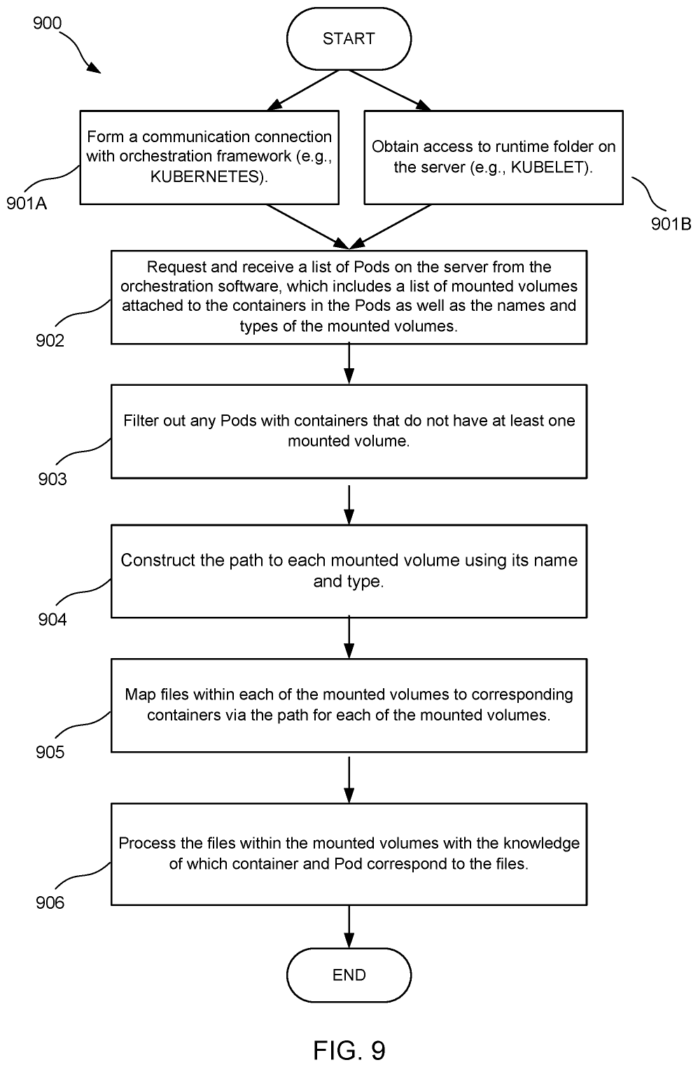

FIG. 9 illustrates a flowchart of an embodiment of a method for operating a data file locator and processing module (such as those shown in FIGS. 5 and 6) where the process for managing containers is an off-server process for complex management of containers (e.g., realized by the KUBERNETES orchestration software). The data file locator and processing module may be arranged on a server hosting the data file locator and processing module, running in its own container or as a process on the server. A server can be at least one of a computing device or a virtual machine. In other embodiments, the data file locator and processing module may be arranged outside of the server. The data file locator and processing module may first obtain access to the runtime folder (e.g., KUBELET runtime folder) on a server, on which mounted volumes of containers are stored (Block 901B). For instance, the path “/var/lib/kubelet,” can be used to obtain access to the runtime folder. The data file locator and processing module can also form a communication connection with the orchestration framework (e.g., KUBERNETES orchestration software) (Block 901A). KUBELET is a part of the KUBERNETES orchestration software that operates on-server to manage an on-server process for basic management of containers, such as a container runtime. Blocks 901A and 901B may occur in any order, so long as they are both completed before Block 902. The data file locator and processing module can then request and receive a list of Pods on the server from the orchestration framework, which includes a list of mounted volumes attached to the containers in the Pods as well as the types and names of the mounted volumes (Block 902). Each Pod is an abstraction that can contain one or more containers. The data file locator and processing module can then filter out any Pods in the list of Pods with containers that do not have at least one mounted volume (Block 903). The data file locator and processing module can then construct the path to each mounted volume using its name and type (Block 904). For instance, each path may be constructed using the format “{kubelet_runtime_folder}/pods/{pod_identifier}/volumes/{type_of_the_volume}/{name_of_the_volume}” where the mounted volume name (name_of_the_volume) and type (type_of_the_volume) are used to designate the path of the mounted volume on the runtime folder (kubelet_runtime_folder) for a given Pod (pod_identifier). Using the filtered list of Pods, the data file locator and processor module can then map files within each of the mounted volumes to corresponding containers and Pods via the path for each of the mounted volumes (Block 905). Finally, the data file locator and processing module can process the files within the mounted volumes with the knowledge of which container and Pod correspond to the files (Block 906) without some of the potential drawbacks of the naming, logging library, sidecar, or piggyback approaches described above. In some embodiments, the files within the mounted volumes of the containers can contain logging data from the processes and subprocesses of the containers. With the knowledge of which container and Pod correspond to specific files, memory and processor usage can be reduced by processing only a subset of all the mounted volumes or a subset of files within the mounted volumes, rather than processing all mounted volumes as required in the art.

In some embodiments of the current disclosure, the data file locator and processing module can introduce annotations or labels to be attached to the containers by a process for managing containers (e.g., 504, 605) or a system for managing containers (e.g., 604). These annotations can then be used as a control mechanism for the data file locator and processing module. For example, annotations can be used to define a subset of data files to process, where the subset can be defined by at least one of data file type (e.g., only log files), one or more volumes on which the data files are stored, or a user-created subset definition. In a logging-based application, annotations could be used to specify one or more volumes on which the data file locator and processing module processes log files, avoiding the additional processing of some extraneous data files. Alternatively, in a file backup application, annotations could be used to specify a subset of data files for the data file locator and processing module to process in a backup procedure.

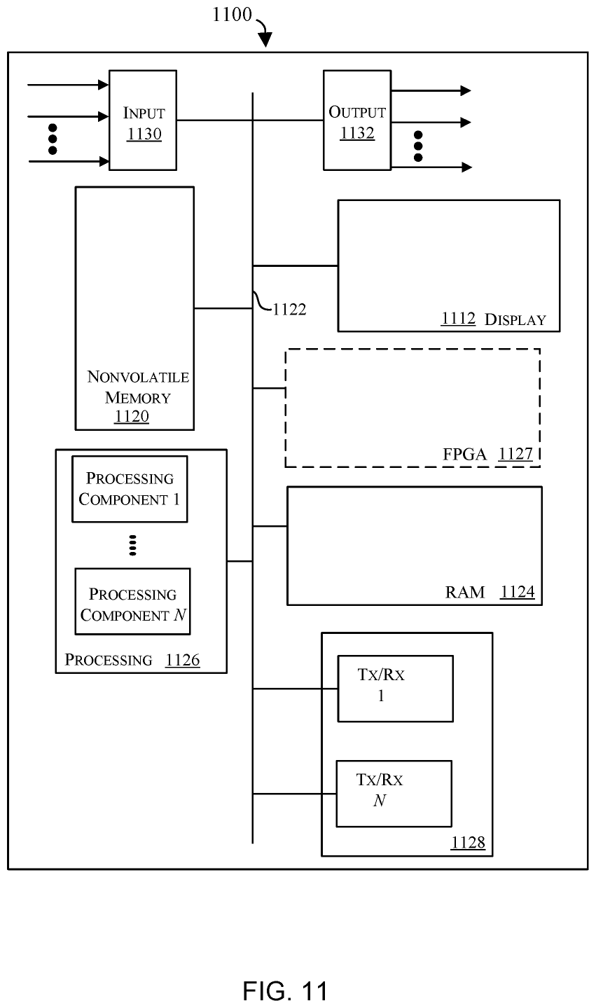

The methods described in connection with the embodiments disclosed herein may be embodied directly in hardware, in processor-executable code encoded in a non-transitory tangible processor readable storage medium, or in a combination of the two. Referring to FIG. 11 for example, shown is a block diagram depicting physical components that may be utilized to realize the data file locator and processing module (and the server generally) according to an exemplary embodiment. As shown, in this embodiment a display portion 1112 and nonvolatile memory 1120 are coupled to a bus 1122 that is also coupled to random access memory (“RAM”) 1124, a processing portion (which includes N processing components) 1126, an optional field programmable gate array (FPGA) 1127, and a transceiver component 1128 that includes N transceivers. Although the components depicted in FIG. 11 represent physical components, FIG. 11 is not intended to be a detailed hardware diagram; thus many of the components depicted in FIG. 11 may be realized by common constructs or distributed among additional physical components. Moreover, it is contemplated that other existing and yet-to-be developed physical components and architectures may be utilized to implement the functional components described with reference to FIG. 11.

This display portion 1112 generally operates to provide a user interface for a user, and in several implementations, the display is realized by a touchscreen display. In general, the nonvolatile memory 1120 is non-transitory memory that functions to store (e.g., persistently store) data and processor-executable code (including executable code that is associated with effectuating the methods described herein). In some embodiments for example, the nonvolatile memory 1120 includes bootloader code, operating system code, file system code, and non-transitory processor-executable code to facilitate the execution of a method described with reference to FIGS. 7-9 described further herein.

In many implementations, the nonvolatile memory 1120 is realized by flash memory (e.g., NAND or ONENAND memory), but it is contemplated that other memory types may be utilized as well. Although it may be possible to execute the code from the nonvolatile memory 1120, the executable code in the nonvolatile memory is typically loaded into RAM 1124 and executed by one or more of the N processing components in the processing portion 1126.

The N processing components in connection with RAM 1124 generally operate to execute the instructions stored in nonvolatile memory 1120 to enable locating of files in mounted volumes created by processes running in operating system (e.g., LINUX) containers. For example, non-transitory, processor-executable code to effectuate the methods described with reference to FIGS. 7-9 may be persistently stored in nonvolatile memory 1120 and executed by the N processing components in connection with RAM 1124. As one of ordinarily skill in the art will appreciate, the processing portion 1126 may include a video processor, digital signal processor (DSP), micro-controller, graphics processing unit (GPU), or other hardware processing components or combinations of hardware and software processing components (e.g., an FPGA or an FPGA including digital logic processing portions).

In addition, or in the alternative, the processing portion 1126 may be configured to effectuate one or more aspects of the methodologies described herein (e.g., the method described with reference to FIGS. 7-9). For example, non-transitory processor-readable instructions may be stored in the nonvolatile memory 1120 or in RAM 1124 and when executed on the processing portion 1126, cause the processing portion 1126 to perform methods for decreasing process and memory resources used to locate one or more files in mounted volumes created by processes running in one or more operating system containers. Alternatively, non-transitory FPGA-configuration-instructions may be persistently stored in nonvolatile memory 1120 and accessed by the processing portion 1126 (e.g., during boot up) to configure the hardware-configurable portions of the processing portion 1126 to effectuate the functions of the data file locator and processing module (e.g., 506, 606).

The input component 1130 operates to receive signals (e.g., user commands or configuration files) that are indicative of one or more aspects of the user desire or file system (e.g., 512, 612). The signals received at the input component may include, for example, configuration files from a user or a list of containers and volume locations. The output component generally operates to provide one or more analog or digital signals to effectuate an operational aspect of the data file locator and processing module. For example, the output portion 1132 may provide a located data file or log forwarding from the mounted volumes described with reference to FIGS. 5 and 6.

The depicted transceiver component 1128 includes N transceiver chains, which may be used for communicating with external devices via wireless or wireline networks. Each of the N transceiver chains may represent a transceiver associated with a particular communication scheme (e.g., WiFi, Ethernet, Profibus, etc.).

Some portions are presented in terms of algorithms or symbolic representations of operations on data bits or binary digital signals stored within a computing system memory, such as a computer memory. These algorithmic descriptions or representations are examples of techniques used by those of ordinary skill in the data processing arts to convey the substance of their work to others skilled in the art. An algorithm is a self-consistent sequence of operations or similar processing leading to a desired result. In this context, operations or processing involves physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these and similar terms are to be associated with appropriate physical quantities and are merely convenient labels. Unless specifically stated otherwise, it is appreciated that throughout this specification discussions utilizing terms such as “processing,” “computing,” “calculating,” “determining,” and “identifying” or the like refer to actions or processes of a computing device, such as one or more computers or a similar electronic computing device or devices, that manipulate or transform data represented as physical electronic or magnetic quantities within memories, registers, or other information storage devices, transmission devices, or display devices of the computing platform.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

As used herein, the recitation of “at least one of A, B and C” is intended to mean “either A, B, C or any combination of A, B and C.” The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. A system for decreasing processor and memory resources used to locate one or more files in mounted volumes created by processes running in one or more operating system containers, the system comprising:
a processing portion with one or more processing components therein;
a memory coupled to the processing portion;
a process for managing containers;
a server stored on the memory and executable on the processing portion, the server comprising:
one or more containers, external to the process for managing containers, having at least one process;
a file system having mounted volumes, wherein the storage locations of the mounted volumes are on the server yet external to the one or more containers, the mounted volumes each being mounted to one or more of the one or more containers;
a data file locator and processing module, external to the process for managing containers, stored on the memory and executable on the processing portion to:
form a communication connection with the process for managing containers;
request and receive, a list of containers, from the process for managing containers, on the server having mounted volumes on the file system, along with a path to each of these mounted volumes;
obtain access to the file system; and
map files on the file system for all mounted volumes created by the process for managing containers to corresponding containers via the path for each of the mounted volumes without analyzing all containers on the server, where each of the files is created by a process running on a corresponding one of the containers.

2. The system of claim 1, wherein the process for managing containers operates on the server.

3. The system of claim 2, wherein the process for managing containers is a container runtime.

4. The system of claim 1, wherein the process for managing containers operates outside the server.

5. The system of claim 4, wherein the process for managing containers is an orchestration framework.

6. The system of claim 1, wherein the server operates within a virtual machine.

7. The system of claim 1, wherein the request and receive includes (1) requesting and receiving a list of all mounted volumes on the file system and (2) a list of all containers associated with those mounted volumes.

8. The system of claim 1, wherein the request and receive includes (1) requesting and receiving a list of all containers on the server, (2) requesting and receiving a list of all mounted volumes on the file system, and (3) requesting and receiving a path to each of the mounted volumes.

9. A method for decreasing processor and memory resources used to locate one or more files in mounted volumes created by processes running in one or more operating system containers, the method comprising:
forming a communication connection with a process for managing containers;
requesting and receiving a list of containers on a server, at least one of the containers having a mounted volume on the file system, and further receiving a path to each of the mounted volumes;
obtaining access to a file system of the server; and
mapping files on the file system for all mounted volumes created by the process for managing containers to corresponding containers via the path for each of the mounted volumes, where each of the files is created by a process running on a corresponding one of the containers.

10. The method of claim 9, wherein the process for managing containers is arranged on a server hosting the data file locator and processing module.

11. The method of claim 10, wherein the process for managing containers is a container runtime.

12. The method of claim 9, wherein the process for managing containers is arranged outside a server hosting the data file locator and processing module.

13. The method of claim 12, wherein the process for managing containers is an orchestration framework.

14. The method of claim 1, wherein the server operates within a virtual machine.

15. A data file locator and processing module configured for storage on a memory of a server and configured to execute on a processing portion of the server, the server having one or more containers, external to the process for managing containers, and at least one of the one or more containers having a mounted volume having a storage location on the server's file system yet external to the one or more containers, the server further having a process for managing containers internal to the server and interacting with a system for complex management of containers external to the server, the data file locator and processing module comprising:
a communication connection sub module configured to form a communication connection with the process for managing containers internal to the server;
a path locator sub module configured to, via the communication connection, request and receive a list of all containers, from the process for managing containers, on the server having mounted volumes on the file system, along with a path to each of these mounted volumes;
an access sub module configured to obtain access to the file system; and
a mapper sub module configured to map files on the file system for all mounted volumes created by the process for managing containers to corresponding containers via the path for each of the mounted volumes, rather than utilizing a file name of the mounted volumes, where each of the files is created by a process running on a corresponding one of the containers.

16. The data file locator and processing module of claim 15, wherein the process for managing containers is arranged on a server hosting the data file locator and processing module.

17. The data file locator and processing module of claim 16, wherein the process for managing containers is a container runtime.

18. The data file locator and processing module of claim 15, wherein the system for complex management of containers is arranged outside a server hosting the data file locator and processing module.

19. The data file locator and processing module of claim 18, wherein the system for complex management of containers is an orchestration framework.
